(19) United States
(12) Patent Application Publication
(10) Pub. No.: US 2024/0010864 A1
(43) Pub. Date: Jan. 11, 2024

(54) TINT PASTE

(71) Applicant: PPG Industries Ohio, Inc., Cleveland, OH (US)

(72) Inventors: Antonio Belletti, Allison Park, PA (US); Nadine D. Colwell, Glenshaw, PA (US)

(73) Assignee: PPG Industries Ohio, Inc., Cleveland, OH (US)

(21) Appl. No.: 18/246,043

(22) PCT Filed: Sep. 16, 2021
(86) PCT No.: PCT/US2021/050624

§ 371 Date: Mar. 21, 2023

Related U.S. Application Data
(60) Provisional application No. 63/082,988, filed on Sep. 24, 2020.

(51) Int. Cl. C09D 17/00; C09D 7/45; C09D 7/65; C09D 7/40; C09D 101/14; C09D 7/80

(52) U.S. Cl. CPC C09D 17/003; C09D 17/002; C09D 7/45; C09D 7/65; C09D 7/67; C09D 101/14; C09D 7/80

(57) ABSTRACT

A tint paste includes a solvent, a pigment, and a dispersant composition. The dispersant composition includes a plurality of dispersants including: a first dispersant including an acrylic co-polymer, where the first dispersant includes a nitrogen-containing anchor group; and a second dispersant including an acrylic co-polymer free of a nitrogen-containing anchor group. A coating composition including a resin and the tint paste is also disclosed.

### FIELD OF THE INVENTION

The present invention relates to a tint paste, a coating composition including the tint paste, and a method of preparing the coating composition.

### BACKGROUND OF THE INVENTION

Tint pastes may include a solvent, pigment, and dispersant composition and may be combined with a resin to form a coating composition. The coating composition may be applied over substrates and coalesced to form a coating. For example, coating compositions including tint pastes may be applied over vehicles (e.g., automobiles) either as the initial coating composition applied thereover or as a refinish coating composition.

Certain dispersant compositions are not suitable as the sole dispersant composition for refinish applications due to their incompatibility with cellulose acetate butyrate (CAB) resin in the refinish coating composition. However, certain cellulose acetate butyrate compatible dispersant compositions, when used as the sole dispersant composition with cellulose acetate butyrate will not impart the desired high transparency and stable chroma to the resulting refinish coating formed from the refinish coating composition.

### SUMMARY OF THE INVENTION

The present invention relates to a tint paste, including a solvent, a pigment, and a dispersant composition. The dispersant composition includes a plurality of dispersants including: a first dispersant including an acrylic co-polymer, where the first dispersant includes a nitrogen-containing anchor group and a second dispersant including an acrylic co-polymer free of a nitrogen-containing anchor group.

The present invention also relates to a coating composition, including: a resin and a tint paste, including: a solvent, a pigment, and a dispersant composition. The dispersant composition includes a plurality of dispersants including: a first dispersant including an acrylic co-polymer, where the first dispersant includes a nitrogen-containing anchor group and a second dispersant including an acrylic co-polymer free of a nitrogen-containing anchor group.

The present invention also relates to a method for preparing a coating composition, including: preparing a tint paste including a solvent, a pigment, and a dispersant composition. The dispersant composition includes a plurality of dispersants including: a first dispersant including an acrylic co-polymer, where the first dispersant includes a nitrogen-containing anchor group, and a second dispersant including an acrylic co-polymer free of a nitrogen-containing anchor group; and preparing a coating composition including a resin and the tint paste.

### BRIEF DESCRIPTION OF THE DRAWING

FIG. 1 shows sectional side elevational view of a coated article having a repaired damaged area; and

FIG. 2 shows a bar graph of percent haze for each of the coatings of Examples 1-5.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and the plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” pigment, “a” dispersant, and the like refer to one or more of any of these items. Also, as used herein, the term “polymer” is meant to refer to prepolymers, oligomers, and both homopolymers and co-polymers. The term “resin” is used interchangeably with “polymer”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

The term “coalesced” refers to the process by which a coating composition hardens to form a coating. Coalescing may include the coating composition being cured (e.g., hardening by being crosslinked, either by itself or via a crosslinking agent) and/or the coating composition being dried.

The present invention is directed to a tint paste comprising a solvent, a pigment, and a dispersant composition. The dispersant composition comprises a plurality of dispersants comprising: a first dispersant comprising an acrylic co-polymer, wherein the first dispersant comprises a nitrogen-containing anchor group; and a second dispersant comprising an acrylic co-polymer, wherein the second dispersant is free of an anchor group comprising nitrogen.

The solvent of the tint paste may include water, an organic solvent, or some combination thereof. Non-limiting examples of organic solvents include, but are not limited to, esters of carboxylic acids, ethers, ketones, cyclic ethers, C5-C10 alkanes, C5-C8 cycloalkanes, aromatic hydrocarbon solvents, halogenated hydrocarbon solvents, amides, nitrites, sulfoxides, sulfones, and/or aromatic hydrocarbon solvents (such as xylene, toluene), or mixtures thereof. The solvent may include a supercritical solvent, such as supercritical CO₂, C1-C4 alkanes, and/or fluorocarbons, or mixtures thereof. Any mixture of these solvents may be used.

The pigment of the tint paste may be selected from inorganic pigments, such as carbon black pigments, e.g., furnace blacks, electrically conductive carbon black pigments, extender pigments and corrosion inhibitive pigments, organic pigments and mixtures thereof. Examples of organic pigments that may be present in the pigment dispersion include, but are not limited to, perylenes, phthalo green, phthalo blue, nitroso pigments, manoazo pigments, diazo pigments, diazo condensation pigments, basic dye pigments, alkali blue pigments, blue lake pigments, phloxin pigments, quinacridone pigments, lake pigments of acid yellow 1 and 3, carbazole dioxazine violet pigments, alizarine lake pigments, vat pigments, phthaloxy amine pigments, carmine lake pigments, tetrachloroisoindolinone pigments, and mixtures thereof. Inorganic pigments that may be present in the pigment dispersion, include, for example, titanium dioxide, electrically conductive titanium dioxide, and iron oxides, e.g., red iron oxide, yellow iron oxide, black iron oxide and transparent iron oxides. Extender pigments that may be present in the pigment dispersion include, but are not limited to, silicas, clays, and alkaline earth metal sulfates, such as calcium sulfate and barium sulfate. The pigment dispersion may contain corrosion inhibitive pigments, such as aluminum phosphate and calcium modified silica. Combinations of any of these pigments may be used.

The pigment in the tint paste may have an average particle size in the range of 10-100 nm, such as 10-50 nm or 20-50 nm. The pigment in the tint paste may have an average particle size up to 100 nm, such as up to 80 nm, up to 70 nm, or up to 50 nm. As discussed herein, average particle size was measured by transmission electron microscope (TEM). This measurement was performed by drop casting a diluted dispersion on a TEM Grid and taking TEM images using a Tecnai T20 TEM operating at 200 kV. Images were taken in random areas on each grid. This was accomplished by generating a random number, which was then correlated to a stage location using the navigation grid in the instrument interface. Several different locations at varying magnification were then taken within this area, following the guidelines in ISO/DIS 21363. The Feret minimum and maximum diameters of each particle were measured in the images. All particles in the images were measured except for those that were touching the border of the image or did not have high enough contrast in the image for a clear measurement. The particle size data, including the average maximum and minimum Feret diameters, standard deviation, and standard error of the mean for each sample were recorded. The average maximum Feret diameter was reported as the average particle size unless stated otherwise.

The tint paste may include up to 40 weight percent pigment, based on total solids of the tint paste, such as up to 35 weight percent, up to 30 weight percent, up to 25 weight percent, up to 20 weight percent, up to 15 weight percent, up to 13 weight percent, up to 12 weight percent, or up to 10 weight percent. Total solids is determined herein according to ASTM D2369-10. The tint paste may include from 15-30 weight percent pigment, based on total solids of the tint paste, such as from 15-25 weight percent, from 20-25 weight percent, or from 18-27 weight percent.

The dispersant composition includes a plurality of dispersants including the first dispersant and the second dispersant.

The first dispersant includes an acrylic co-polymer comprising a nitrogen-containing anchor group. As used herein, a “co-polymer” refers to a polymer formed from the incorporation of least two different monomers to form a polymer chain. As used herein, an “anchor group” refers a pendant group or terminal group bonded to the acrylic co-polymer backbone. The nitrogen-containing anchor group may be resin affinic and/or pigment affinic.

The nitrogen-containing anchor group may be formed from a nitrogen-containing monomer. The nitrogen-containing monomer may include an imidazole monomer, such as n-vinyl imidazole and/or its derivatives, such as 2-methyl N-vinyl imidazole, a dialkylaminoalkyl monomer, such as dimethylaminoethyl (meth)acrylate and/or a dimethylaminoethyl-containing ethylenically unsaturated monomer, 4-vinylpyridine, N-vinylpyrrolidone, acrylamide, N-isopropyl acrylamide, and/or some combination thereof. Accordingly, the acrylic co-polymer of the first dispersant may comprise a dialkylaminoalkyl group, such as a dimethylaminoethyl group, and/or an imidazole group as the nitrogen-containing anchor group. The nitrogen-containing anchor group may include a residue of a tertiary or quaternary amine (e.g., a tertiary or quaternary amine reacted to form the anchor group of the first dispersant). The nitrogen-containing anchor group may have a positive charge.

The residue of the monomer comprising the nitrogen-containing anchor group may be present in the acrylic co-polymer of the first dispersant in an amount of from 0.1 to 40 weight percent, such as from 10 to 40 weight percent, from 15 to 40 weight percent, or from 15 to 30 weight percent, based on the total weight of the residues of the monomers that are present in the acrylic co-polymer of the first dispersant.

The first dispersant may be compatible with the resin used in the later described coating composition. The first dispersant may be compatible with a resin comprising cellulose acetate butyrate. The nitrogen-containing anchor group of the first dispersant can result in the compatibility with the resin, such as with the cellulose acetate butyrate. The first dispersant may be compatible with the resin, such as cellulose acetate butyrate, in a coating composition in which the first dispersant is the sole dispersant and the coating composition comprises the resin, alone or in combination with other resins. A dispersant may be “compatible with” a target resin (e.g., cellulose acetate butyrate) when the percent haze of a coalesced coating prepared from a coating composition including the dispersant as the sole dispersant and including the target resin (e.g., the target resin as the sole resin in the coating composition) is not more than 2% higher than the haze of a coalesced coating prepared from a coating composition including the sole dispersant and at least one other binder resin, assuming the compared coating compositions have the same pigment loading. A dispersant or combination of dispersants may be compatible with a target resin(s) if the haze value of the composition is less than or equal to 11%, such as less than or equal to 10%, or less than or equal to 9%. Haze was measured herein by drawdown method in which the coating composition is applied over a black and white byko-chart opacity chart (or similar chart) using a #70 wired wound bar and coalesced to form a coating. The L*110 and C*15 were measured by a BykMac i spectrophotomer (catalog number 7037), according to the handbook thereof, and haze was calculated as (L*110*100)/C*15.

The second dispersant comprises an acrylic co-polymer free of a nitrogen-containing anchor group. The anchor group may be resin affinic and/or pigment affinic. The second dispersant may include an acrylic co-polymer free of nitrogen.

The second dispersant may include a cycloaliphatic anchor group. As used herein, “cycloaliphatic” refers to a cyclic arrangement of the constituent carbon atoms which may be saturated or paraffinic in nature, unsaturated (e.g., containing non-aromatic carbon-carbon double bonds), or acetylenic (e.g., containing carbon-carbon triple bonds).

The second dispersant can comprise an anchor group comprising an aromatic group, such as an aromatic hydrocarbon, such as naphthalene. The aromatic group may include naphthoic acid, hydroxy naphthoic acid, anthracene, anthraquinone, phenanthrene, pyrene, and/or derivatives and/or mixtures thereof. The monomers reacted to prepare the second dispersant comprising an anchor group comprising an aromatic group may comprise an oxirane functional monomer reacted with a carboxylic acid which may be an aromatic carboxylic acid or polycyclic aromatic carboxylic acid, including, e.g., phenyl(meth)acrylate, benzyl(meth)acrylate; polycyclic aromatic (meth)acrylates, e.g., 2-naphthyl(meth)acrylate. The oxirane functional monomer or its residue that is reacted with a carboxylic acid may be selected from, for example, glycidyl(meth)acrylate, 3,4-epoxycyclohexylmethyl(meth)acrylate, 2-(3,4-epoxycyclohexyl)ethyl(meth)acrylate, allyl glycidyl ether, and/or some combination thereof. Examples of carboxylic acids that may be reacted with the oxirane functional monomer or its residue include, but are not limited to, naphthoic acid, hydroxy naphthoic acids (e.g., 3-hydroxy-2-napthoic acid), and/or some combination thereof.

The second dispersant may be incompatible with the resin used in the later described coating composition. The second dispersant may be incompatible with a resin comprising cellulose acetate butyrate. The second dispersant may be incompatible with the resin, such as cellulose acetate butyrate, in a coating composition in which the second dispersant is the sole dispersant and the coating composition comprises the resin, alone or in combination with other resins.

The weight ratio of the first dispersant to the second dispersant in the tint paste may range from 9:1 to 1:9, such as from 3:1 to 1:3, from 2.5:1 to 1:2.5, from 1:1 to 4.5:1, from 1.25:1 to 4.5:1, from 1.5:1 to 3.5:1, based on the weights of the first dispersant and second dispersant included in the tint paste.

The first dispersant and/or the second dispersant may include an acrylic block co-polymer. As used herein, a “block co-polymer” refers to a co-polymer comprising at least two regions (blocks) of the polymer chain which are rich in a different characteristic monomer species and/or combination of monomer species. The following include non-limiting examples of block co-polymers formed from different monomer species A, B, and/or C:

| Block | |
|---|---|
| Co-Polymer | Arrangement |
| (1) | AAAAAAAAAABBBBBBBBBB |
| (2) | BBBBBBBBBBAAAAAAAAAA |
| (3) | AAAAABBBBBBBBBBAAAAA |
| (4) | AAABBBAAABBBAAABBBAAA |
| (5) | AAAABAABABBBABBBBBBBB |
| (6) | AAAAAAAAAABCBCBCBCBCBC |
| (7) | ABABABABABCBCBCBCBCB |

The block co-polymer may include at least two blocks rich in a different characteristic monomer species and/or combination of monomer species, wherein each of the two blocks may include at least 2, such as at least 3, at least 4, at least 5, at least 6, at least 7, or more consecutive bonded units derived from the same characteristic monomer species and/or combination of monomer species (see e.g., Block Co-Polymers (1)-(6)). Block Co-Polymers (1)-(5) show structures in which a block rich in monomer species A and a block rich in monomer species B are included, wherein the blocks include 100% of monomer species A and 100% of monomer species B, respectively. However, it will be appreciated that a block may include less than 100% of a monomer species and/or combination of monomer species and still be rich in that monomer species and/or combination of monomer species (e.g., a block itself may be a co-polymer) (see e.g., Block Co-Polymers (6)-(7)). For a block to be rich in a particular monomer species and/or combination of monomer species, it may contain a comparatively higher percent of that characteristic monomer species and/or combination of monomer species compared to other blocks contained in the polymer. For a block to be rich in a particular monomer species and/or combination of monomer species, it may contain a particular monomer species and/or combination of monomer species unique to that block and not present in any other block of the polymer. For a block to be rich in a particular monomer species and/or combination of monomer species, it may contain at least 50% of the monomer species and/or combination of monomer species, such as at least 60%, at least 70%, at least 80%, at least 90%, or at least 95%, based on moles of monomer species contained in the block.

Block Co-Polymer (6) shows a block co-polymer including a first block including 100% of monomer species A and a second block including 50% of monomer species B and 50% of monomer species C (or 100% of combination of monomer species BC). The second block is rich in monomer species B, monomer species C, and/or combination of monomer species BC, relative to the first block. The pattern of the monomer species B and C in the second block may be alternating (as shown) or include some other pattern or be random.

Block Co-Polymer (7) shows a block co-polymer that includes a first block rich in monomer species A and a second block rich in monomer species C, wherein monomer species A is a monomer species unique to the first block, and monomer species C is a monomer species unique to the second block, such that monomer species A is a characteristic monomer of the first block and monomer species C is a characteristic monomer of the second block.

The block co-polymer may include a single block of each of the two different blocks having a different monomer species and/or combination of monomer species (see e.g., Block Co-Polymers (1)-(2) and (6)-(7)) or the block co-polymer may include a plurality of blocks having the same monomer species and/or combination of monomer species (see e.g., Block Co-Polymers (3)-(5)).

The blocks in the block co-polymer may be arranged in any order. For example, Block Co-Polymers (1) and (2) include the same two blocks but arranged in a different order. The order and/or arrangement of the blocks may be controlled so as to form a block co-polymer having the desired performance characteristics.

The block co-polymer may have an arrangement of the blocks characteristic of a gradient block co-polymer. A gradient block co-polymer is a block co-polymer including a first plurality of blocks rich in the same first monomer species and/or combination of monomer species, each of the first plurality of blocks separated by at least one second plurality of blocks rich in a different monomer species and/or combination of monomer species. The concentration of the first monomer species and/or combination of monomer species exhibits a gradual change along the length of the block co-polymer. As such, the length of each block of the first plurality of blocks (each separated by at least one second plurality of blocks) may change along the length of the polymer to attain the gradient change in composition therealong. A non-limiting example of a gradient block co-polymer includes Block Co-Polymer (5), which has a higher concentration of monomer species A at the first end and a higher concentration of monomer species B at the second end by the length of the A blocks and B blocks gradually changing along the length of the polymer.

While the structures of Block Co-Polymers (1)-(7) have been illustrated to be aligned in a linear arrangement, the block co-polymer may have a non-linear arrangement. For example, the block co-polymer may be a graft block co-polymer, a comb block co-polymer, a brush block co-polymer, a star block co-polymer, and the like.

The block co-polymer may include a block which is a pigment affinic block. The pigment affinic block may be polar (e.g., include a polar molecule). An intermolecular attractive force may exist between proximate pigment affinic blocks and the pigment, when dispersed together in the tint paste and/or the coating composition. The intermolecular attractive force may include, but is not limited to, van der Waals forces, pi stacking forces, and/or some combination thereof. The intermolecular attractive forces may be measured by methods known to those having ordinary skill in the art. Without being bound by a particular theory, the existence of the intermolecular attractive forces between the pigment affinic block and the pigment may allow the coating composition to remain stable as a homogenous composition. This may be evidenced by data such as the haze and/or chroma data described in the Examples contained herein.

The block co-polymer may include a block which is a resin affinic (resin compatible) block. The resin affinic block may be non-polar (e.g., include a non-polar molecule). An intermolecular attractive force may exist between proximate resin affinic blocks and the resin, when dispersed together in the coating composition. The intermolecular attractive force may include, but is not limited to, van der Waals forces, pi stacking forces, and/or some combination thereof. The intermolecular attractive forces may be measured by methods known to those having ordinary skill in the art. Without being bound by a particular theory, the existence of the intermolecular attractive forces between the resin affinic block and the resin may allow the coating composition to remain stable as a homogenous composition. This may be evidenced by data such as the haze and chroma data described in the Examples contained herein.

The block co-polymer may include both a pigment affinic block and a resin affinic block or the block co-polymer may include either the pigment affinic block or the resin affinic block. The first dispersant may include the pigment affinic block and/or the resin affinic block. The second dispersant may include the pigment affinic block and/or the resin affinic block.

The present invention is also directed to a coating composition including a resin and the tint paste as previously described.

The resin in the coating composition may include cellulose acetate butyrate. The coating composition may comprise from 7-52 weight percent resin (e.g., cellulose acetate butyrate), such as from 10-50 weight percent, from 15-45 weight percent, or from 20-40 weight percent based on total solids of the coating composition. The coating composition may comprise up to 52 weight percent resin (e.g., cellulose acetate butyrate), such as up to 50 weight percent, up to 45 weight percent, or up to 40 weight percent, based on total solids of the coating composition. The coating composition may comprise at least 7 weight percent resin (e.g., cellulose acetate butyrate), such as at least 10 weight percent, at least 15 weight percent, at least 20 weight percent, or at least 25 weight percent, based on total solids of the coating composition.

The resin in the coating composition, such as cellulose acetate butyrate, may have a number average molecular weight (Mn) of from 500-70,000, such as from 500-1,500, from 12,000-70,000, from 30,000-70,000, or from 40,000-70,000. As specified herein, Mn was measured by gel permeation chromatography using a polystyrene standard according to ASTM D6579-11 performed using a Waters 2695 separation module with a Waters 2414 differential refractometer (RI detector); tetrahydrofuran (THF) was used as the eluent at a flow rate of 1 ml/min, and two PLgel Mixed-C (300×7.5 mm) columns were used for separation at the room temperature; weight and number average molecular weight of polymeric samples can be measured by gel permeation chromatography relative to linear polystyrene standards of 800 to 900,000 Da).

The resin in the coating composition may include components such as hydroxyl or carboxylic acid-containing acrylic copolymers and/or hydroxyl or carboxylic acid-containing polyester polymers and oligomers, and/or isocyanate or hydroxyl-containing polyurethane polymers, and/or amine or isocyanate-containing polyureas which can enhance cure rate, appearance, and other physical properties of the coalesced coating.

The acrylic polymers may be copolymers of acrylic acid or methacrylic acid or hydroxyalkyl esters of acrylic or methacrylic acid such as hydroxyethyl methacrylate or hydroxypropyl acrylate with one or more other polymerizable ethylenically unsaturated monomers such as alkyl esters of acrylic acid including methyl (meth)acrylate, butyl (meth)acrylate, and 2-ethyl hexyl (meth)acrylate, isobutyl (meth)acrylate, benzyl (meth)acrylate, stearyl (meth)acrylate, lauryl (meth)acrylate, methoxy-PEG (meth)acrylate, and vinyl aromatic compounds such as styrene, alpha-methyl styrene and vinyl toluene, and/or some combination thereof. The polymerizable ethylenically unsaturated monomers may include vinyl pyrrolidone, 4-vinyl pyridine, dimethylaminoethyl acrylate (DMAEMA), and/or some combination thereof. The ratio of reactants and reaction conditions may be selected to result in an acrylic polymer with pendant hydroxyl or carboxylic acid functionality. The acrylic polymer may be prepared from a hydroxyl functional acrylic monomer reacting with a (di)lactone ring-opening type monomer, such as caprolactone, lactide, and the like reacting in a ring-opening reaction with an alcohol, such as a polyhydric alcohol.

The coating composition may include a polyester polymer or oligomer. Such polymers may be prepared by condensation of polyhydric alcohols and polycarboxylic acids. Suitable polyhydric alcohols may include ethylene glycol, neopentyl glycol, trimethylol propane, pentaerythritol, hydroxyl terminated poly(ethylene oxide) and/or poly(propylene oxide), and/or some combination thereof. Suitable polycarboxylic acids may include adipic acid, 1,4-cyclohexyl dicarboxylic acid, hexahydrophthalic acid, and/or some combination thereof. Besides the polycarboxylic acids mentioned above, functional equivalents of the acids such as anhydrides where they exist or lower alkyl esters of the acids such as the methyl esters may be used. Fatty acids, such as lauric acid, stearic acid, palmitic acid, linoleic acid, oleic acid, and the like may be used. Where it is desired to enhance air-drying, suitable drying oil fatty acids may be used and include those derived from linseed oil, soya bean oil, tall oil, dehydrated castor oil or tung oil. The polyester polymer or oligomer may be prepared using (di)lactone ring-opening type monomers such as caprolactone, lactide, and the like reacting in a ring-opening reaction with an alcohol, such as the previously described polyhydric alcohols. The polyesters may contain free terminal hydroxyl and/or carboxyl groups that are available for further crosslinking reactions. Hydroxyl-containing polyester oligomers can be prepared by reacting an anhydride of a dicarboxylic acid such as hexahydrophthalic anhydride with a diol such as neopentyl glycol in a 1:2 molar ratio.

Polyurethane polymers containing terminal isocyanate or hydroxyl groups may also be used. The polyurethane polyols or NCO-terminated polyurethanes that can be used are those prepared by reacting polyols including polymeric polyols with polyisocyanates. The polyurea-containing terminal isocyanate or primary or secondary amine groups which can be used are those prepared by reacting polyamines including polymeric polyamines with polyisocyanates. The hydroxyl/isocyanate or amine/isocyanate equivalent ratio may be adjusted and reaction conditions selected to obtain the desired terminal group.

The coating composition may include a crosslinker to cure the coating composition to form a coating. The crosslinker for the coating composition may include an aminoplast resins and/or a phenoplast resin (e.g., a melamine resin), as crosslinkers for OH and COON and amide and carbamate functional group containing materials. The crosslinker may include a polyisocyanates and/or a blocked polyisocyanate for OH and primary and/or secondary amino group containing materials. The crosslinker may include an anhydride for OH and primary and/or secondary amino group containing materials. The crosslinker may include a polyepoxide for COON functional group containing materials. The crosslinker may include a polyacid for epoxy functional group containing materials. The crosslinker may include a polyol for NCO functional group containing materials and anhydrides and esters. The crosslinker may include polyamines for NCO functional group containing materials and for carbonates and unhindered esters. The coating composition may be cured at ambient temperatures (e.g. 20° C. to 25° C.) or from ambient temperatures to 90° C., or from ambient temperatures to 80° C., or from ambient temperatures to 70° C., or from ambient temperatures to 60° C., or from 40° C. to 80° C., or from 40° C. to 70° C. The coating composition can also be cured at temperatures of less than 140° C., or less than 120° C., or less than 100° C., or less than 80° C. The coating composition can be cured at these temperatures for a period of time of 30 minutes or less, 20 minutes or less, 10 minutes or less, or 5 minute or less to allow the crosslinking reaction to run substantially to completion (at least 90% or 95% to completion) to form the cured coating. The coating composition can be cured at these temperatures for a period of time ranging from 5-30 minutes, such as from 5-25 minutes, from 5-20 minutes, from 5-15 minutes, or from 5-10 minutes to allow the crosslinking reaction to run substantially to completion to form the cured coating.

The coating composition may be coalesced to form the coating by drying the coating composition. The coating composition may be substantially free (less than 2 weight percent of the coating composition), essentially free (less than 1 weight percent of the coating composition, or free (0 weight percent of the coating composition) of a crosslinker. The coating composition can be dried at ambient temperatures (e.g. 20° C. to 25° C.) or from ambient temperatures to 90° C., or from ambient temperatures to 80° C., or from ambient temperatures to or from ambient temperatures to 60° C., or from 40° C. to 80° C., or from 40° C. to 70° C. The coating composition can also be dried at temperatures of less than 140° C., or less than 120° C., or less than 100° C., or less than 80° C. The coating composition can be dried at these temperatures for a period of time of 30 minutes or less, 20 minutes or less, 10 minutes or less, or 5 minute or less to allow the substantially all of the solvent (such as at least 90 weight percent of the solvent, at least 95 weight percent solvent, at least 99 weight percent solvent, or 100 weight percent solvent) to be evaporated, as determined by ASTM D2369-10(2015)e1. The coating composition can be dried at these temperatures for a period of time ranging from 5-30 minutes, such as from 5-25 minutes, 5-20 minutes, 5-15 minutes, or 5-10 minutes to allow the substantially all of the solvent to be evaporated.

The coating composition may include up to 30 weight percent tint paste, based on total solids of the coating composition, such as up to 25 weight percent, up to 20 weight percent, up to 15 weight percent, or up to 10 weight percent. The coating composition may include at least 0.1 weight percent tint paste, based on total solids of the coating composition, such as at least 1 weight percent, at least 5 weight percent, at least 10 weight percent, at least 15 weight percent, or at least 20 weight percent. The coating composition may include from 0.1-30 weight percent tint paste, based on total solids of the coating composition, such as from 1-30 weight percent, from 5-30 weight percent, from 10-30 weight percent, from 15-30 weight percent, from 20-30 weight percent, from 25-30 weight percent, from 1-25 weight percent, from 5-25 weight percent, from 10-25 weight percent, from 15-25 weight percent, from 5-20 weight percent, or from 10-20 weight percent.

The coating composition may include up to 5 weight percent pigment, based on total solids of the coating composition, such as up to 4 weight percent, up to 3 weight percent, or up to 2 weight percent. The coating composition may include at least 0.005 weight percent pigment, based on total solids of the coating composition, such as at least 0.1 weight percent, at least 0.5 weight percent, at least 1 weight percent, at least 2 weight percent, or at 3 weight percent. The coating composition may include from 0.005-5 weight percent pigment, based on total solids of the coating composition, such as from 0.1-5 weight percent, from 1-5 weight percent, from 2-5 weight percent, from 3-5 weight percent, from 0.1-3 weight percent, from 0.1-2 weight percent, or from 1-3 weight percent.

The coating composition may include one or more further additives, such as plasticizers, surfactants, antioxidants, ultraviolet light absorbers, stabilizers, rheology control agents, flow control agents, thixotropic agents such as bentonite clay, coalescing agents, organic co-solvents, pigments, fillers, catalysts, abrasion resistant particles, and/or other customary auxiliaries.

The coating composition, when applied to a substrate and coalesced (e.g., dried and/or cured) to form a coating, may exhibit a lower haze compared to the same coating composition except excluding one of the first dispersant and the second dispersant from the tint paste (e.g., the tint paste includes the first dispersant or the second dispersant but not the combination of both).

The coating composition may be prepared by preparing the tint paste previously described by mixing the solvent, the pigment, and the dispersant composition. During preparation of the tint paste, the mixture of the solvent, the pigment, and the dispersant composition may be ground until the pigment contained therein has an average particle size (as previously described) in the range of from 10-100 nm, such as from 10-50 nm or from 20-50 nm. The coating composition may be prepared by combining the tint paste and the resin, such as by mixing the prepared tint paste with the resin previously described.

A substrate may by coated by applying the coating composition as described herein over at least a portion of the substrate. The coating composition may be applied to the substrate using any application technique, such as electrocoating, spraying, electrostatic spraying, dipping, rolling, brushing, and the like.

The substrate over which the coating composition may be applied includes a wide range of substrates. For example, the coating composition of the present invention can be applied to a vehicle component, an industrial component, an architectural component, an aerospace component, and the like.

In the present disclosure, the term “vehicle” is used in its broadest sense and includes all types of aircraft, spacecraft, watercraft, and ground vehicles. For example, the vehicle can include, but is not limited to an aerospace component, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like. The vehicle can also include a ground vehicle such as, for example, trailers, animal trailers (e.g., horse trailers), cars, trucks, buses, vans, heavy duty equipment, golf carts, motorcycles, bicycles, trains, railroad cars, and the like. The vehicle can also include watercraft such as, for example, ships, boats, hovercraft, and the like. In some examples, the coating composition may be applied over a surface of a F/A-18 jet (or derivations or variants thereof, such as, for example, the F/A-18E Super Hornet and F/A-18F; produced by McDonnell Douglas/Boeing and Northrop) and/or the Boeing 787 Dreamliner, 737, 747, and/or 717 passenger jet aircraft (or derivations or variants thereof; produced by Boeing Commercial Airplanes); V-22 Osprey; VH-92 and S-92 (or derivations or variants thereof; produced by NAVAIR and Sikorsky); the G650, G600, G550, G500 and G450 (or derivations or variants thereof; produced by Gulfstream); and the A350, A320, and/or A330 (or derivations or variants thereof; produced by Airbus). The coating composition may be applied over a surface of a military, or general aviation aircraft such as, for example, those produced by Bombardier Inc. and/or Bombardier Aerospace (e.g., the Canadair Regional Jet (CRJ) and derivatives thereof), Lockheed Martin (e.g., the F-22 Raptor, the F-35 Lightning, and derivatives thereof), Northrop Grumman (e.g., the B-2 Spirit and derivatives thereof), Pilatus Aircraft Ltd., and Eclipse Aviation Corporation or Eclipse Aerospace (now Kestrel Aircraft).

The coating composition may be applied over an architectural component, such as concrete, stucco, masonry elements, cement board, MDF (medium density fiberboard) and particle board, gypsum board, wood, stone, metal, plastics (e.g., vinyl siding and recycled plastics), wall paper, textiles, plaster, fiberglass, ceramic, and the like, which may be pre-primed by waterborne or solvent borne primers. The architectural component may be an interior wall (or other interior surface) of a building or residence. The architectural component may be an outdoor substrate exposed to outdoor conditions. The architectural component may be smooth or textured.

The coating composition may be applied over an industrial component which may include tools, heavy duty equipment, furniture such as office furniture (e.g., office chairs, desks, filing cabinets, and the like), appliances such as refrigerators, ovens and ranges, dishwashers, microwaves, washing machines, dryers, small appliances (e.g., coffee makers, slow cookers, pressure cookers, blenders, etc.), metallic hardware, extruded metal such as extruded aluminum used in window framing, other indoor and outdoor metallic building materials, and the like.

The coating composition may be applied over storage tanks, windmills, nuclear plants, packaging substrates, wood flooring and furniture, apparel, electronics, including housings and circuit boards, glass and transparencies, sports equipment, including golf balls, stadiums, buildings, bridges, and the like.

The substrate may be a metallic or non-metallic component. Metallic substrates include, but are not limited to, tin, steel (including electrogalvanized steel, cold rolled steel, hot-dipped galvanized steel, steel alloys, or blasted/profiled steel, among others), aluminum, aluminum alloys, zinc-aluminum alloys, steel coated with a zinc-aluminum alloy, and aluminum plated steel. As used herein, blasted or profiled steel refers to steel that has been subjected to abrasive blasting and which involves mechanical cleaning by continuously impacting the steel substrate with abrasive particles at high velocities using compressed air or by centrifugal impellers. The abrasives are typically recycled/reused materials and the process can efficiently remove mill scale and rust. The standard grades of cleanliness for abrasive blast cleaning is conducted in accordance with BS EN ISO 8501-1.

Further, non-metallic substrates include polymeric substrates, such as polyester, polyolefin, polyamide, cellulosic, polystyrene, polyacrylic, poly(ethylene naphthalate), polypropylene, polyethylene, nylon, ethylene vinyl alcohol (EVOH), polylactic acid (PLA), other “green” polymeric substrates, poly(ethylene terephthalate) (PET), polycarbonate, polycarbonate acrylobutadiene styrene (PC/ABS), polyamide, and/or plastic composite substrates such as glass or carbon fiber composites. The non-metallic substrates may include wood, veneer, wood composite, particle board, medium density fiberboard, cement, stone, glass, paper, cardboard, textiles, leather both synthetic and natural, and the like.

The substrate may include a packaging substrate. A package may be coated at least in part with any of the coating compositions described above. A “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage package or bakeware in which a consumer might make and/or store food; such a package would only maintain the freshness or integrity of the food item for a relatively short period. “Package” as used herein means the complete package itself or any component thereof, such as an end, lid, cap, and the like. For example, a “package” coated with any of the coating compositions described herein might include a metal can in which only the can end or a portion thereof is coated. A package according to the present invention can be made of metal or non-metal, for example, plastic or laminate, and be in any form. An example of a suitable package is a laminate tube. Another example of a suitable package is metal can. The term “metal can” includes any type of metal can, package or any type of receptacle or portion thereof that is sealed by the food/beverage manufacturer to minimize or eliminate spoilage of the contents until such package is opened by the consumer. One example of a metal can is a food can; the term “food can(s)” is used herein to refer to cans, packages or any type of receptacle or portion thereof used to hold any type of food and/or beverage. “Beverage can” may also be used to refer more specifically to a food can in which a beverage is packaged. The term “metal can(s)” specifically includes food cans, including beverage cans, and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating composition may be applied to the interior and/or the exterior of the package. For example, the coating can be applied onto metal used to make a two-piece food can, two-piece beverage can, a three-piece food can, can end stock and/or cap/closure stock. The coating can be applied to the “side stripe” of a metal can, which will be understood as the seam formed during fabrication of a three-piece can. The coating can also be applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans. The coating can be applied to can stock before formation of the can or can part, or can be applied to the can or can part after formation.

Any material used for the formation of food cans can be treated according to the present methods. Particularly suitable substrates include aluminum, tin-plated steel, tin-free steel, and black-plated steel.

The present invention therefore further includes a method of coating a package comprising applying to at least a portion of the package any of the coating compositions described above, and coalescing the coating composition to form the coating. Two-piece cans are manufactured by joining a can body (typically a drawn metal body) with a can end (typically a drawn metal end). The coatings of the present invention are suitable for use in food contact situations and may be used on the inside of such cans. They are particularly suitable to be spray applied on the interior of two-piece drawn and ironed beverage cans and coil coatings for food can ends. The present invention also offers utility in other applications. These additional applications include, but are not limited to, wash coating, sheet coating, and side seam coatings (e.g., food can side seam coatings).

Spray coating includes the introduction of the coating composition into the inside of a preformed package. Typical preformed packages suitable for spray coating include food cans, beer and beverage packages, and the like. The spray may utilize a spray nozzle capable of uniformly coating the inside of the preformed package. The sprayed preformed package is then subjected to heat to remove the residual solvents and harden the coating. For food inside spray, the coalescing conditions involve maintaining the temperature measured at the can dome at 350° F. to 500° F. (177° C. to 260° C.) for 0.5 to 30 minutes.

A sheet coating is described as the coating of separate pieces of a variety of materials (e.g., steel or aluminum) that have been pre-cut into square or rectangular “sheets.” Typical dimensions of these sheets are approximately one square meter. Once coated to form a coating composition over each sheet, the coating composition is coalesced to form a coated sheet. Once coalesced (e.g., dried and/or cured), the sheets of the coated substrate are collected and prepared for subsequent fabrication. Sheet coatings provide coated metal (e.g., steel or aluminum) substrate that can be successfully fabricated into formed articles, such as 2-piece drawn food cans, 3-piece food cans, food can ends, drawn and ironed cans and the like.

A side seam coating is described as the spray application of a coating over the welded area of formed three-piece food cans. When three-piece food cans are being prepared, a rectangular piece of coated substrate is formed into a cylinder. The formation of the cylinder is rendered permanent due to the welding of each side of the rectangle via thermal welding. Once welded, each can typically requires a layer of coating, which protects the exposed “weld” from subsequent corrosion or other effects to the contained foodstuff. The coatings that function in this role are termed “side seam stripes”. Typical side seam stripes are spray applied and coalesced quickly via residual heat from the welding operation in addition to a thermal, infrared, and/or electromagnetic oven.

Any of the tint pastes described herein may be mixed with any of the resins described herein to form a primer coating composition and/or a color imparting basecoat composition. Any of the tint pastes described herein may be mixed with a clearcoat composition to impart a color to the clearcoat composition.

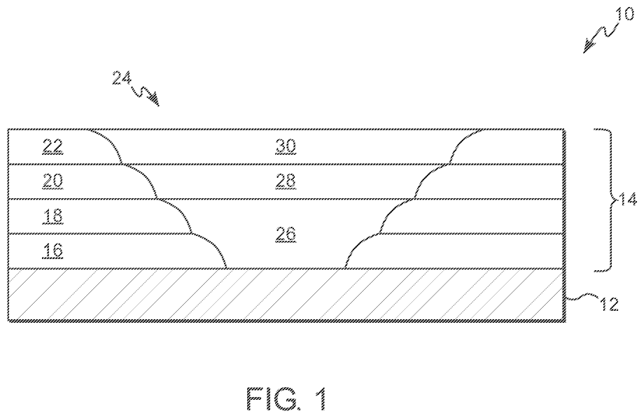

Referring to FIG. 1, the coating composition may be applied over a damaged portion of a substrate as a refinish coating composition. FIG. 1 shows a repaired coated substrate 10. The repaired coated substrate 10 may include a repaired vehicle component, such as a repaired automobile component.

The repaired coated substrate 10 may include a substrate 12 over which a multi-layer coating stack 14 is formed. The multi-layer coating stack 14 may include an electrodeposited layer (electrocoat layer) 16 over at least a portion of the substrate 12. The multi-layer coating stack 14 may include an original primer layer 18 over at least a portion of the electrocoat layer 16. The multi-layer coating stack 14 may include an original basecoat layer 20 over at least a portion of the original primer layer 18. The multi-layer coating stack 14 may include an original clearcoat layer 22 over at least a portion of the original basecoat layer 20.

The repaired coated substrate may include a damaged portion. The damaged portion may include a portion of the multi-layer coating stack 14 that has been removed or otherwise damaged and/or a damaged portion of the substrate 12. The damaged portion may be repaired to form a repaired damaged portion 24 using at least one refinish coating composition, such as the refinish coating composition described herein. The repaired damaged portion 24 may include a repair primer layer 26 over at least a portion of the substrate 12 and/or the electrocoat layer 16. The repaired damaged portion 24 may include a repair basecoat layer 28 over at least a portion of the repair primer layer 26. The repaired damaged portion 24 may include a repair clearcoat layer 30 over at least a portion of the repair basecoat layer 28. The coating composition described herein may be used as a composition to form at least one of the repair primer layer 26, repair basecoat layer 28, and repair clearcoat layer 30. The coating composition described herein may be used as a composition to form the repair basecoat layer 28. The tint paste described herein may be added to a repair clearcoat composition to impart a color to the repair clearcoat layer 30.

### EXAMPLES

The following examples are presented to demonstrate the general principles of the invention. The invention should not be considered as limited to the specific examples presented. All parts and percentages in the examples are by weight unless otherwise indicated.

### Examples 1-5

### Preparation of Tint Pastes

Tint pastes for Examples 1-5 were prepared by mixing the components listed in Table 1 to form Tint Pastes 1-5, respectively:

TABLE 1

| | Comparative | | | | Comparative |
|---|---|---|---|---|---|
| | Tint Paste 1 | Tint Paste 2 | Tint Paste 3 | Tint Paste 4 | Tint Paste 5 |
| Components | (grams) | (grams) | (grams) | (grams) | (grams) |
| MONOLITE | 10.5 | 10.5 | 10.5 | 10.5 | 10.5 |
| Blue 3R-H | | | | | |
| Pigment Blue | | | | | |
| 60¹ | | | | | |
| Acrylic co- | — | 15.3 | 12.2 | 7.7 | 30.5 |
| polymer free of a | | | | | |
| nitrogen- | | | | | |
| containing | | | | | |
| anchor group² | | | | | |
| Acrylic co- | 43.5 | 21.7 | 26.2 | 32.7 | — |
| polymer | | | | | |
| comprising a | | | | | |
| nitrogen- | | | | | |
| containing | | | | | |
| anchor group³ | | | | | |
| n-butylacetate | 23 | 26.25 | 25.55 | 24.55 | — |
| Butyl | 23 | 26.25 | 25.55 | 24.55 | 45 |
| CELLOSOLVE⁴ | | | | | |
| n-butyl | — | — | — | — | 14 |
| propionate | | | | | |

¹Blue pigment, commercially available from Heubach GmbH (Langelsheim, Germany)
²Dispersant prepared according to Synthesis Example A of U.S. Pat. No. 8,129,466 B2
³EFKA PX 4350 containing an acrylic co-polymer comprising a nitrogen-containing anchor group, commercially available from BASF (Ludwigshafen, Germany)
⁴Solvent, commercially available from Dow Chemical Company (Midland, MI)

Tint Pastes 1-5 were each combined with 143 grams of SPHERIGLASS 2227 silica glass beads (Potters Industries LLC (Valley Forge, PA)) and mixed on a Lau disperser for 16 hours.

### Preparation of Coating Compositions

1.15 weight percent of Tint Pastes 1-5 were each mixed with 98.85 weight percent of DBC 500 DELTRON Color Blender (PPG Industries, Inc. (Pittsburgh, PA)), which contains a blend of cellulose acetate butyrate (CAB) and a polyacrylate and containing an amount of CAB within the previously defined CAB range, and was stirred by hand using a spatula to form Coating Compositions 1-5, respectively.

### Evaluation of Coating Compositions

Coating Compositions 1-5 were each applied over a black and white byko-chart opacity charts using a #70 wired wound bar and left to dry to form Coatings 1-5. Color values of Coatings 1-5 were measured using a BYK-mac i 23 mm spectrophotometer. The color values were reported based on ASTM E308-17, and the test results are shown in Table 2.

TABLE 2

| Color | Comparative | | | | Comparative |
|---|---|---|---|---|---|
| Measurement | Coating 1 | Coating 2 | Coating 3 | Coating 4 | Coating 5 |
| L* 110 | 3.01 | 2.24 | 1.91 | 1.79 | 3.26 |
| C* 15 | 41.04 | 38.14 | 45.88 | 50.59 | 23.39 |
| Haze | 7.33 | 5.87 | 4.16 | 3.54 | 13.94 |

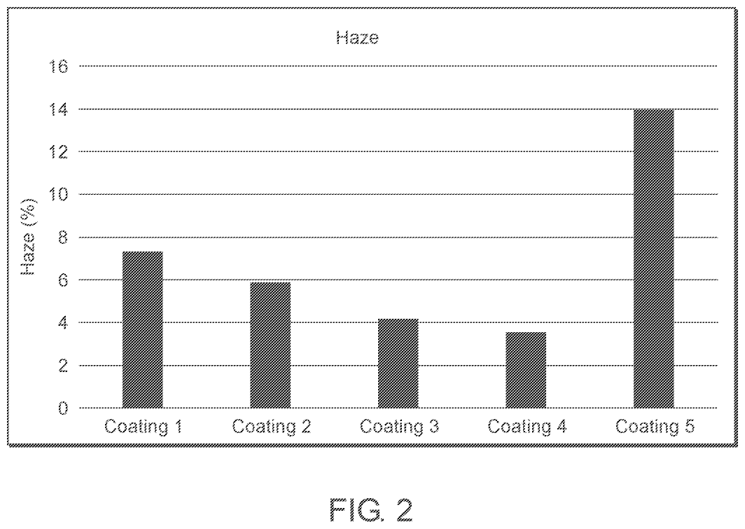

FIG. 2 shows a bar graph of percent haze for each of Coatings 1-5. As can be seen from the graph, Coatings 2-4, including a blend of cellulose acetate butyrate compatible dispersant and cellulose acetate butyrate incompatible dispersant in the tint paste used to form the coating, display a lower percent haze compared to Coating 1, formed using a tint paste including only the cellulose acetate butyrate compatible dispersant, and Coating 5, formed using a tint paste including only the cellulose acetate butyrate incompatible dispersant. Therefore, the combination of the cellulose acetate butyrate compatible dispersant and cellulose acetate butyrate incompatible dispersant (Coatings 2-4) resulted in an unexpected low haze in comparison with compositions that only comprise one of the dispersants (Comparative Coatings 1 and 5), indicating a synergistic effect realized by combining these dispersants.

Whereas particular embodiments of this invention have been described above for purposes of illustration, it will be evident to those skilled in the art that numerous variations of the details of the present invention may be made without departing from the invention as defined in the appended claims.

1. A tint paste, comprising a solvent, a pigment, and a dispersant composition, wherein the dispersant composition comprises a plurality of dispersants comprising:
a first dispersant comprising an acrylic co-polymer, wherein the first dispersant comprises a nitrogen-containing anchor group; and
a second dispersant comprising an acrylic co-polymer free of a nitrogen-containing anchor group.

2. The tint paste of claim 1, wherein the second dispersant comprises a cycloaliphatic group and/or an aromatic group as an anchor group.

3. The tint paste of claim 1, wherein the nitrogen-containing anchor group comprises a residue of a tertiary or quaternary amine.

4. The tint paste of claim 1, wherein the pigment has an average particle size in the range of from 10-100 nm.

5. (canceled)

6. The tint paste of claim 1, wherein the tint paste comprises up to 40 weight percent of the pigment, based on total solids weight of the tint paste.

7. (canceled)

8. The tint paste of claim 1, wherein a coalesced coating prepared from a coating composition including a binder and the tint paste including the first dispersant and the second dispersant exhibits a lower haze compared to the same coating composition except excluding one of the first dispersant and the second dispersant.

9. The tint paste of claim 8, wherein: the first coating composition, when cured to form a coating, exhibits a haze value of less than or equal to 11; and the second coating composition, when cured to form a coating, exhibits a haze value of greater than 11.

10. The tint paste of claim 1, wherein:
the first dispersant is compatible with cellulose acetate butyrate; and
the second dispersant is incompatible with cellulose acetate butyrate.

11. The tint paste of claim 1, wherein the acrylic co-polymer of the first dispersant comprises a dialkylaminoalkyl group, such as a dimethylaminoethyl group, and/or an imidazole group as the nitrogen-containing anchor group.

12. (canceled)

13. The tint paste of claim 1, wherein the residue of the monomer comprising the nitrogen-containing anchor group is present in the acrylic co-polymer of the first dispersant in an amount of 0.1 to 40 weight percent, such as 10 to 40 weight percent, based on the total weight of the residue of the monomers that are present in the acrylic co-polymer of the first dispersant.

14. (canceled)

15. A coating composition, comprising:
a resin; and
a tint paste, such as the tint paste according to claim 1, comprising:
a solvent, a pigment, and a dispersant composition, wherein the dispersant composition comprises a plurality of dispersants comprising:
a first dispersant comprising an acrylic co-polymer, wherein the first dispersant comprises a nitrogen-containing anchor group; and
a second dispersant comprising an acrylic co-polymer free of a nitrogen-containing anchor group.

16. The coating composition of claim 15, wherein the second dispersant comprises a cycloaliphatic group and/or an aromatic group as an anchor group.

17. The coating composition of claim 15, wherein the nitrogen-containing anchor group comprises a residue of a tertiary or quaternary amine.

18. The coating composition of claim 15, wherein the pigment has an average particle size in the range of from 10-100 nm.

19. The coating composition of claim 15, wherein the coating composition comprises up to 5 weight percent of the pigment, based on total solids weight of the coating composition.

20. (canceled)

21. The coating composition of claim 15, wherein:
the first dispersant is compatible with cellulose acetate butyrate in a first coating composition in which the first dispersant is the sole dispersant, the first coating composition comprising cellulose acetate butyrate; and
the second dispersant is incompatible with cellulose acetate butyrate in a second coating composition in which the second dispersant is the sole dispersant, the second coating composition comprising cellulose acetate butyrate.

22. The coating composition of claim 15, wherein the resin comprises cellulose acetate butyrate.

23. A substrate coated with the coating composition of claim 15.

24. The substrate of claim 23, wherein the substrate comprises a vehicle component, an architectural component, an industrial component, and/or an aerospace component.

25. (canceled)

26. A method for preparing a coating composition, such as the coating composition according to claim 15, comprising:
preparing a tint paste, such as the tint paste according to claim 1, comprising a solvent, a pigment, and a dispersant composition, wherein the dispersant composition comprises a plurality of dispersants comprising:
a first dispersant comprising an acrylic co-polymer, wherein the first dispersant comprises a nitrogen-containing anchor group; and
a second dispersant comprising an acrylic co-polymer free of a nitrogen-containing anchor group; and
combining a resin and the tint paste to form the coating composition.

27-29. (canceled)
